(19) United States
(12) Patent Application Publication
(10) Pub. No.: US 2025/0040746 A1
(43) Pub. Date: Feb. 6, 2025

(54) SEPARABLE FILTER HOLDER FOR AN ESPRESSO COFFEE MACHINE

(71) Applicant: LA MARZOCCO S.R.L., SCARPERIA E SAN PIERO (IT)

(72) Inventors: Simone GUCCI, SCARPERIA E SAN PIERO (IT); Stefano DELLA PIETRA, SCARPERIA E SAN PIERO (IT); Riccardo MARCHI, SCARPERIA E SAN PIERO (IT); Riccardo GATTI, SCARPERIA E SAN PIERO (IT)

(21) Appl. No.: 18/716,448

(22) PCT Filed: Dec. 6, 2022
(86) PCT No.: PCT/IB2022/061844

§ 371 Date: Jun. 4, 2024

(30) Foreign Application Priority Data
Dec. 9, 2021 (IT) 102021000030959

(51) Int. Cl. A47J 31/06; A47J 31/44

(52) U.S. Cl. CPC A47J 31/0663; A47J 31/446

(57) ABSTRACT

A filter holder for a machine for preparing and dispensing espresso coffee is described, said filter holder comprising a handle, a body connected to the handle and configured to house a filter for ground coffee, and a base cup, wherein the base cup is a component which is separate and/or separable from the body. According to embodiments, the body comprises a first front flange with a first internal groove, a second rear flange with a second internal groove, and two opposite open recesses, wherein the base cup comprises a first front tooth configured to engage the first internal groove and a second rear tooth configured to engage the second internal groove for coupling the base cup to the body.

### BACKGROUND

The present invention relates to the sector of espresso coffee machines. More particularly, it relates to a separable filter holder, which is particularly practical from various points of view.

### PRIOR ART

Many machines for preparing beverages are known. In particular, many machines for the preparation of espresso coffee from coffee powder, pods, capsules or the like are known.

Typically, in a machine for the preparation of espresso coffee, a puck of ground coffee is crossed by a water flow under high pressure and at a high temperature. In some of the known machines it is possible to adjust precisely the pressure and/or the temperature of the water which crosses the puck of coffee. In some known machines, it is possible to modify the pressure and/or the temperature of the water during dispensing.

Typically, an espresso coffee machine comprises at least one dispensing unit on which a filter holder arm—also referred to simply as “filter holder”—is mounted.

The filter holder generally comprises a body and a handle. The body has a substantially cylindrical cross-section and is open at the top. A filter, which is a cup-shaped receptacle with a bottom having a plurality of small holes, is housed inside the filter holder body. A certain amount of ground coffee is filled inside the filter and is generally compressed by the barista manually or using special devices.

Typically, the body of the filter holder has a bottom configured so as to direct the coffee produced towards an outlet spout which creates a flow of espresso coffee and guides it towards a coffee cup. The output spout may be single or double.

Typically the body of the filter holder is made of metallic material, for example steel or brass.

US 2021/219768 A1, DE 21 2016 000160 U1, CN 105 326 393 A and EP 2 087 818 A1 describe filter holders.

### SUMMARY OF THE INVENTION

Typically the body of the filter holder is made of metallic material, for example steel or brass. The body of the filter holder is typically made as one piece with the bottom.

The Applicant has realized that the fact that the filter holder body is made as one piece results in drawbacks and is any case not very practical.

For example, the Applicant has realized it is not always possible to perform proper cleaning of the filter holder because the bottom of the filter holder body is difficult to access.

Moreover, the Applicant has realized that there is a need to have two filter holders, one with a single spout (for one cup of coffee) and one with a double spout (for two cups of coffee).

Furthermore, the Applicant has realized that, on some occasions, it would be desirable to be able to remove the bottom of the filter holder in order to be able to view the espresso coffee flowing out from the bottom of the filter in order to check, for example, that the espresso coffee flows out uniformly and not along particular paths.

The Applicant has defined the aim of providing a filter holder in which the body may be separated from the bottom, for example in order to carry out thorough cleaning operations and to replace the bottom part.

According to the Applicant, the problem may be solved by providing a filter holder with a—for example metallic—body which can be separated from a bottom part. The two parts may be separated from each other or coupled together again.

According to one aspect of the invention, a filter holder for a machine for preparing and dispensing espresso coffee is provided, said filter holder comprising a handle, a body connected to the handle and configured to house a filter for ground coffee, and a base cup, wherein the base cup is a component which is separate and/or separable from the body.

The body may comprise a support member for supporting the filter holder to facilitate pressing of the ground coffee inside the filter.

The support member may comprise a tooth protruding radially towards the outside of the body, preferably in a direction substantially opposite to the handle.

According to embodiments, the body comprises a first front flange with a first internal groove, a second rear flange with a second internal groove, and two opposite open recesses between the first front flange and the second front flange, wherein the first internal groove and the second internal groove open out into open recesses, wherein the base cup comprises a first front tooth configured to engage the first internal groove and a second rear tooth configured to engage the second internal groove for releasably coupling the base cup to the body.

This solution with two recesses is particularly advantageous. In fact, the two recesses allow the user to engage the base cup using the fingers of one hand and to rotate it so as to lock or (or unlock it) relative to the filter holder body. As a result of this solution, the user may avoid having to touch the filter holder body which, immediately after use, is very hot and should not be touched. If the recesses were not present, the user would have to remove the base cup by pressing against the dispensing spouts and this operation is obviously to be avoided (so as not to damage, or even break, the spouts). This solution is also advantageous because the filter holder body is lighter without losing its rigidity. Furthermore, the user is able to view better the grooves and immediately understand how to couple the base cup to the filter holder body.

According to embodiments, the first internal groove and the second internal groove are situated in a horizontal plane parallel to the plane of the top edge of the body. This solution is particularly advantageous since the user must only perform a rotational movement in one plane, and not a screwing movement.

According to embodiments, the first front tooth comprises an entry ramp, a substantially flat section and an exit ramp. According to embodiments, the second rear tooth comprises an entry ramp, a substantially flat section and an exit ramp. This solution is advantageous because the base cup may be connected to the filter holder body with a clockwise or anti-clockwise rotational movement. Furthermore, the base cup and the filter holder body may be separated from each other equally well with an anti-clockwise or clockwise rotational movement.

The filter holder may also comprise a retaining member for providing a further retaining action between the base cup and the body.

According to embodiments, the retaining member comprises a ball presser, wherein the substantially flat section of the rear tooth is interrupted by a cylindrical seat which is configured to engage the ball presser.

According to embodiments, the ball presser is situated in the second groove and the prestressing mechanism is housed in a protruding part of the handle. In this embodiment, the seat for the spring of the ball presser does not increase the thickness of the filter holder body.

The filter holder may also comprise a protruding lug configured to engage the free edge of the second rear flange.

The filter holder may also comprise oppositely arranged whiskers configured to determine the correct angular abutting position of the base cup on the body of the filter holder.

According to embodiments, the filter holder body comprises a first material having a first thermal conductivity and the base cup comprises a second material having a second thermal conductivity, wherein the second thermal conductivity is less than the first thermal conductivity.

The second thermal conductivity is preferably less than 5 W·m⁻¹·K⁻¹, preferably is less than 1 W·m⁻¹·K⁻¹, and preferably is between 0.1 W·m⁻¹·K⁻¹ and 0.5 W·m⁻¹·K⁻¹.

The second material may comprise a material chosen from the group comprising: polyethylene, low-density polyethylene, medium-density polyethylene, high-density polyethylene, polytetrafluoroethylene, methacrylate and acetal, or glass, ceramic, porcelain or any combination thereof.

The second material may be chosen from among polysulfides, polyethers, polyaryletherketones, polyphenylsulfones, polysulfones or the like.

According to embodiments, the second material may be polyphenylene sulfide (PPS). For example a material tested and considered to be suitable is Ryton R-4-244 NA, produced by Solvay, which is a high-modulus polyphenylene sulfide (PPS).

According to embodiments, the second material may be polyether ether ketone (PEEK).

According to embodiments, the second material may be polyphenylsulfone (PPSU). For example, a material tested and considered to be suitable is polysulfone (PPSU), called Radel 5100, produced by Solvay, a material with optimum mechanical and thermal characteristics, as well as being food-grade certified.

According to embodiments, the filter holder body is substantially made of a metallic material having a thermal conductivity of less than 150 W·m⁻¹·K⁻¹.

### BRIEF DESCRIPTION OF THE FIGURES

A detailed description of the present invention now follows, being provided purely by way of a non-limiting example, to be read with reference to attached figures in which:

FIG. 1 is an axonometric view of an example of an espresso coffee machine in which the filter holder according to the present invention may be used;

FIGS. 2A, 2B and 2C are various axonometric views of a filter holder body according to an embodiment of the invention;

FIGS. 3A and 3B are two axonometric views of the base cup configured to be coupled together with the filter holder body of FIG. 2;

FIG. 4 is a view of the body and the base cup according to FIGS. 2 and 3 in the separated condition, namely before engagement together;

FIG. 5 is a view of the body and the base cup during a first phase for coupling them together; and

FIGS. 6 and 7 are two axonometric views, from two different angles, of the filter holder body and the base cup coupled together in the final position.

### DETAILED DESCRIPTION

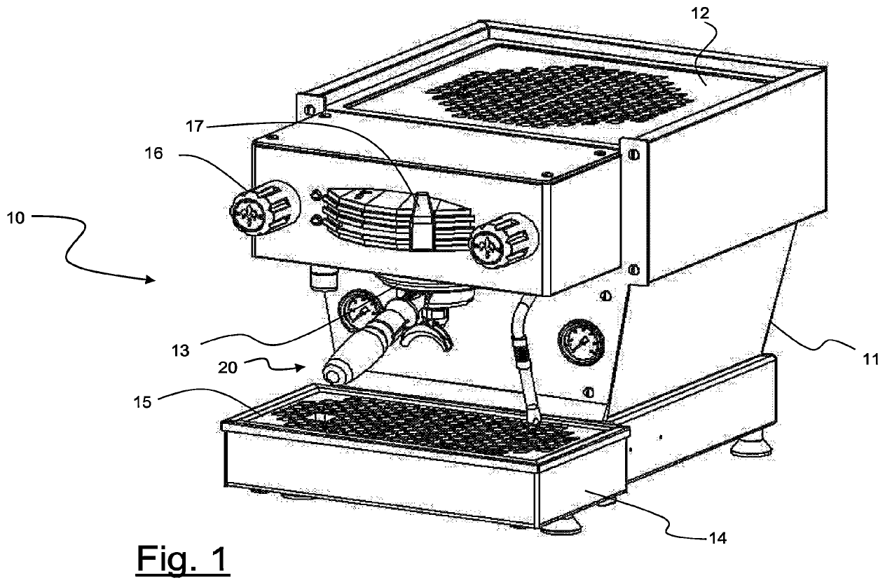

FIG. 1 shows, purely by way of example, an espresso coffee machine, denoted overall by the reference number 10. The machine 10 comprises a substantially closed machine body 11 inside which the main components of the machine—some of which will be described below—are housed. At the top, preferably, the machine 10 comprises a surface 12 for resting the coffee cups. An electric resistance (not shown) or other heating system for heating the cups on the surface 12 may also be provided.

The machine 10 comprises a dispensing unit 13 for dispensing espresso coffee. Underneath the dispensing unit 13 there is preferably arranged a drip tray 14, which is preferably partially closed at the top by a grille 15. Typically, the coffee cups are placed on the grille 15 during dispensing of the espresso coffee.

A filter holder 20, which in turn houses and supports a filter for a puck of coffee powder, can be removably engaged together with the dispensing unit 13.

The machine 10 may comprise one or more displays and/or pushbuttons and/or knobs 16, for example for switching on/off the machine and/or for starting/stopping the dispensing operation.

The machine 10 shown in FIG. 1 also comprises a lever 17 for starting/stopping the dispensing of the espresso coffee and/or for modifying the dispensing pressure during dispensing of the espresso coffee.

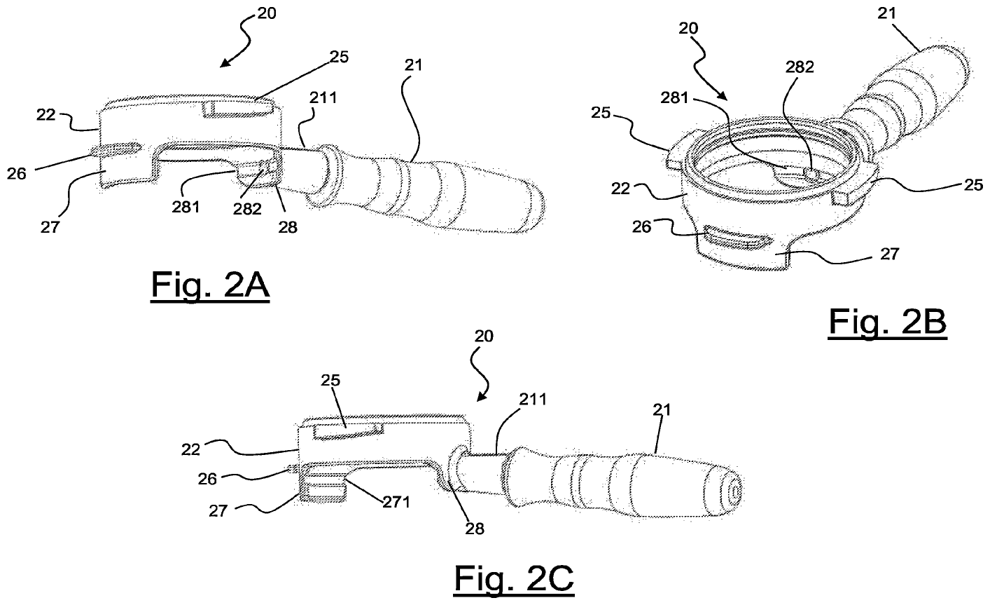

FIG. 2 shows a bottomless filter holder 20 onto which a base cup 30 according to the present invention may be mounted.

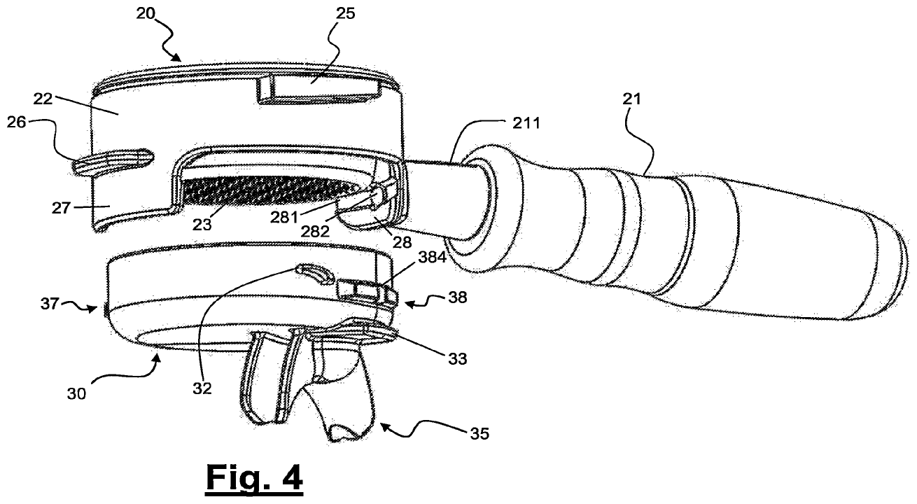

Preferably, the filter holder 20 comprises a handle 21 and a substantially cylindrical body 22 which is configured to retain a filter 23 (FIG. 4) which is filled with coffee powder.

Preferably, the filter 23 is cup-shaped, open at the top and with a closed bottom, but with a plurality of micro-holes on the bottom.

Preferably, a filter-retaining spring clip is provided for keeping the filter 23 in position. The filter-retaining spring clip may be housed inside a groove in the inner wall of the body 22 of the filter holder 20.

Preferably, the outer surface of the filter holder body 22 has, projecting therefrom, two diametrically opposite fins 25, configured to engage the filter holder 20 with the dispensing unit 13. The engagement between the filter holder and the dispensing unit may also be performed by means of a rotational movement, translational movement or combined rotational and translational movement.

The embodiment of the filter holder shown in FIGS. 2-7 is particularly advantageous since the engagement between the filter holder body and the base cup is particularly easy, efficient and resistant. In fact the Applicant has realized that the removal and reassembly operation is dependent on the need for frequent cleaning. Furthermore, since there is the possibility of replacing the base cup easily, it is possible to convert easily a filter holder with double spout into one with a single spout.

The base cup 30 may be made of any material, for example metal, thermoplastic material, glass, ceramic, composite material or a combination thereof.

As shown in FIGS. 2A, 2B and 2C, the body 22 of the filter holder 20 is shaped so as to have a first front flange 27 and a second rear flange 28. Two open recesses, opposite to each other, are thus formed between the two flanges 27 and 28. The first front flange 27 is preferably diametrically opposite to the handle 21. The second rear flange is preferably substantially connected to a protruding part 211 of the handle 21.

According to embodiments, the two flanges 27, 28 follow the substantially cylindrical profile of the body 22 of the filter holder 20.

According to embodiments, the first front flange 27 extends downwards by an amount greater than the second rear flange 28. The reason for this difference will be explained below. The free edge of the second rear flange 28 is preferably rounded.

The first front flange 27 comprises a first internal groove 271. The first internal groove 271 extends over the entire width of the first front flange 27 and opens out into the open recesses.

The second rear flange 28 comprises a second internal groove 281. The second internal groove 281 extends over the entire width of the second flange 28 and opens out into the open recesses.

Preferably, the first internal groove 271 and the second internal groove 281 are situated in a horizontal plane parallel to the plane of the top edge of the body 22.

According to one embodiment, at least one of the grooves comprises a retaining member 282 for keeping the base cup 30 in position when it is coupled to the body 22.

For example, the retaining member 282 may be a ball presser which is elastically prestressed (for example by means of a spring). The ball presser 282 may be situated inside the second groove 28, for example in the center thereof. The prestressing mechanism, which typically comprises a spring, may be housed in a protruding part 211 of the handle 21.

The filter holder body further comprises fins 25 configured to engage the filter holder 20 together with the dispensing unit of the espresso coffee machine.

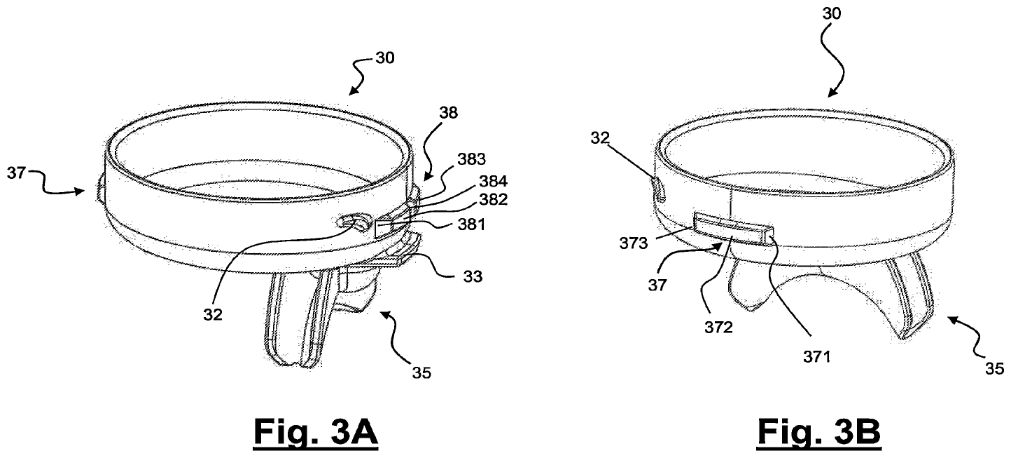

The base cup 30, which is configured to engage with the body 22 of the filter holder 20, is shown in FIGS. 3A and 3B. The base cup 30 has a cup-shaped form which is open at the top and substantially closed at the bottom. A spout 35—which may be single or double spout as shown in FIG. 10 and the following figures—projects from the bottom.

The base cup 30 comprises a side surface with two projecting teeth, a first front tooth 37 and a second rear tooth 38. The two teeth 37, 38 are substantially diametrically opposite to each other. The first front tooth 37 is configured to engage the first front groove 271. The second rear tooth 38 is configured to engage the second rear groove 281.

The first front tooth 37 may comprise an entry ramp 371, a substantially flat section 372 and an exit ramp 373.

Similarly, the second rear tooth 38 may comprise an entry ramp 381, a substantially flat section 382 and an exit ramp 383. The substantially flat section 382 is interrupted by a cylindrical seat 384. The cylindrical seat 384 is configured to engage the retaining member 382 (ball presser).

According to embodiments, the base cup 30 may also comprise a protruding lug 33 which projects radially towards the outside from the bottom of the base cup. The lug 33 is situated preferably substantially underneath the second rear tooth.

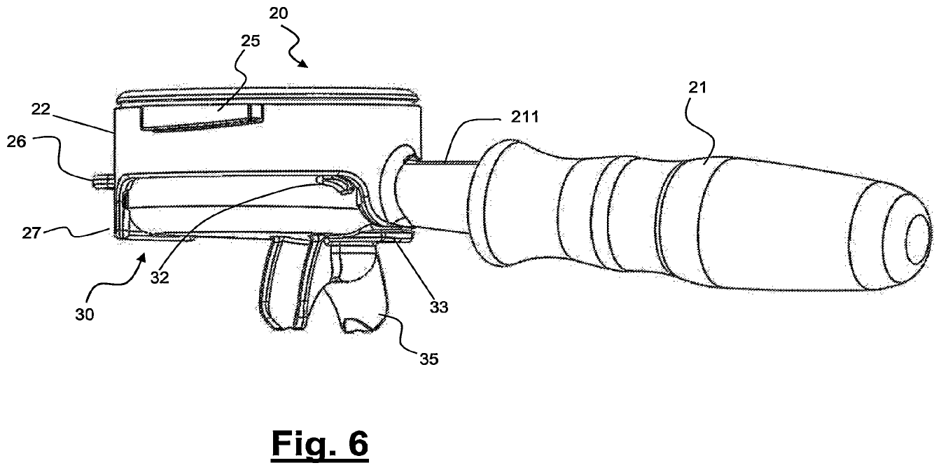

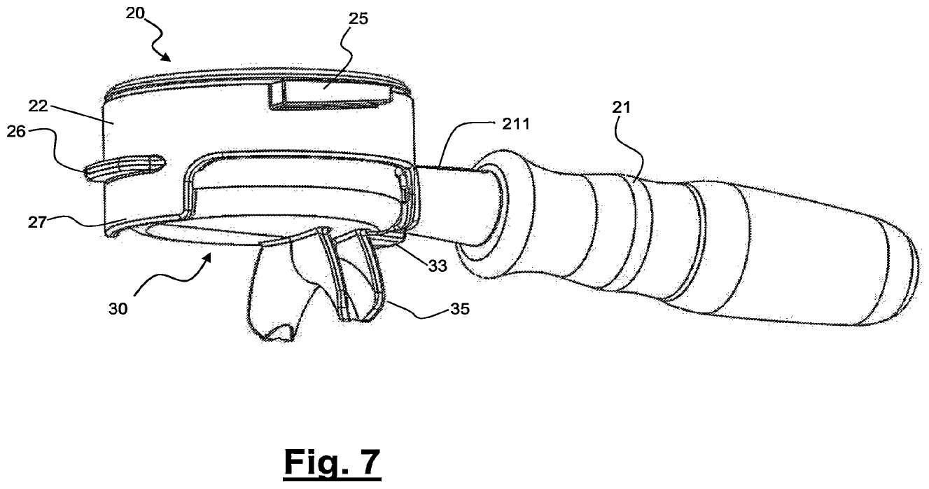

According to embodiments, the outer surface of the base cup 30 also comprises two oppositely arranged projecting whiskers 32. The two oppositely arranged whiskers 32 are configured, as shown in FIGS. 6 and 7, to determine the correct angular abutting position of the base cup 30 on the body 22 of the filter holder 20.

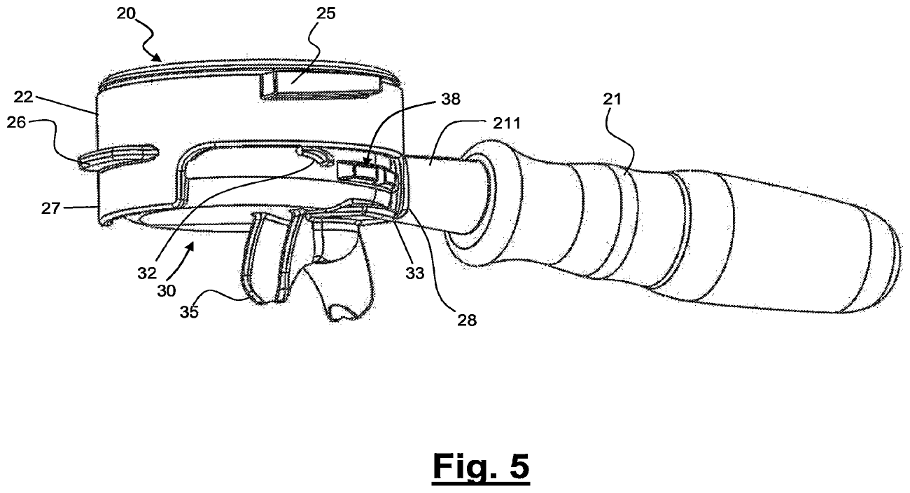

In order to couple the base cup 30 to the filter holder body 22, the base cup 30 is inserted vertically (movement from FIG. 4 to FIG. 5) into the seat of the filter holder and is then rotated so that the first front tooth 37 engages the first front groove 27 and the second rear tooth 38 engages the second rear groove 28. At the end of rotation the base cup is in the position shown in FIGS. 6 and 7.

Advantageously, during the rotational movement, the ball of the ball presser 382 penetrates elastically inside the cylindrical seat 384 of the second tooth 38 and defines with precision the relative position of the base cup 30 and the body 22 of the filter holder. The entry and exit ramps facilitate the retraction of the ball of the ball presser inside its seat.

Furthermore, during the rotational movement, the lug 33 engages the bottom edge of the second rear flange 28. As mentioned above, the second flange 28 extends downwards less than the first flange 27. This in fact defines a unique relative position of the filter holder body and the base cup and prevents these parts from being mounted in a different position. In other words, should one try to rotate the base cup relative to the body in the opposite direction, this rotation would be prevented since the lug would collide against the front flange 27.

In order to remove the base cup 30, it is merely required to rotate the base cup relative to the body 22 of the filter holder, forcing the ball of the ball presser to come out of the cylindrical seat.

It is clear how the embodiment of FIGS. 2-7 is also particularly advantageous since the removal and reassembly operations do not result in any uncertainty in the positioning. The person mounting and removing the base cup is able to easily sense the correct mounting position.

Advantageously, the engaging/disengaging force required to mount/remove the base cup is extremely limited so as to allow essentially anyone to engage/disengage the base cup. This aspect is particularly advantageous when the espresso coffee machine is for domestic use.

Advantageously, according to the invention, the engaged base cup is rigidly retained by the filter holder and becomes essentially an integral part thereof. Accidental removal thereof is prevented even during the more forceful operations involving knocking the filter holder against the coffee grounds drawer in order to remove the used coffee puck.

The body of the filter holder may comprise (or is substantially made of) a first material which has a first thermal conductivity and the base cup may comprise (or is substantially made of) a second material having a second thermal conductivity, wherein the second thermal conductivity is less than the first thermal conductivity.

According to embodiments, the second thermal conductivity is less than 5 W·m⁻¹K⁻¹, preferably is less than 1 W·m⁻¹·K⁻¹, and preferably is between 0.1 W·m⁻¹·K⁻¹ and 0.5 W·m⁻¹·K⁻¹.

According to embodiments, the second material comprises a material selected from the group comprising: polyethylene, low-density polyethylene, medium-density polyethylene, high-density polyethylene, polytetrafluoroethylene, methacrylate and acetal, namely thermoplastic polymers, produced by means of polymerization of aldehydes (formaldehyde, acetaldehyde, etc.) via the carbonyl group.

The Applicant has investigated the use of different materials for manufacture of the base cup. In particular, the Applicant has tested some materials selected from among polysulfides, polyethers, polyaryletherketones, polyphenylsulfones, polysulfones or the like.

According to embodiments, the base cup is substantially made of polyphenylene sulfide, PPS. For example a material tested and considered to be suitable is Ryton R-4-244 NA, produced by Solvay, which is a high-modulus polyphenylene sulfide (PPS).

According to embodiments, the base cup is substantially made of polyether ether ketone (PEEK).

According to embodiments, the base cup is substantially made of polyphenylene sulfone (PPS). For example, a material tested and considered to be suitable is Radel 5100, produced by Solvay, a material with optimum mechanical and thermal characteristics, as well as being food-grade certified.

This material is a polyphenylsulfone (PPSF or PPSU), a polymer made of aromatic rings linked by sulfonyl groups (SO₂).

On the other hand, PBT is a polyester, namely comprising ester repeating units (—COOR).

PPSU is amorphous, while PBT is semi-crystalline.

According to embodiments the base cup is at least partially transparent. The filter holder according to the invention may also be used without the base cup.

When the base cup comprises (or is made of) a material with low thermal conductivity it is possible to remove or reassemble the base cup at any time, even in the case of high temperatures of the filter holder.

1. A filter holder for a machine for preparing and dispensing espresso coffee, comprising a handle, a body connected to the handle and configured to house a filter for ground coffee, and a base cup, wherein the base cup is a component which is separate and/or separable from the body.

2. The filter holder of claim 1, wherein the body comprises a support member for supporting the filter holder to facilitate the pressing of the ground coffee inside the filter.

3. The filter holder of claim 2, wherein the support member comprises a tooth protruding radially towards the outside of the body, preferably in a direction substantially opposite to the handle.

4. The filter holder of claim 1, wherein the body comprises a first front flange with a first internal groove and a second rear flange with a second internal groove, and two opposite open recesses between the first flange and the second flange, wherein the first internal groove and the second internal groove open out into open recesses, wherein the base cup comprises a first front tooth configured to engage the first internal groove and a second rear tooth configured to engage the second internal groove for coupling the base cup to the body.

5. The filter holder of claim 4, wherein the first internal groove and the second internal groove are situated in a horizontal plane parallel to the plane of the top edge of the body.

6. The filter holder of claim 4, wherein the first front tooth comprises an entry ramp, a substantially flat section and an exit ramp.

7. The filter holder of claim 4, wherein the second rear tooth comprises an entry ramp, a substantially flat section and an exit ramp.

8. The filter holder of claim 1, further comprising a retaining member for providing a further retaining action between the base cup and the body.

9. The filter holder of claim 8, wherein the retaining member comprises a ball presser, wherein the substantially flat section of the rear tooth is interrupted by a cylindrical seat which is configured to engage the ball presser.

10. The filter holder of claim 9, wherein the ball presser is situated in the second groove and the prestressing mechanism is housed in a protruding part of the handle.

11. The filter holder of claim 4, further comprising a protruding lug configured to engage the free edge of the second rear flange.

12. The filter holder of claim 4, further comprising oppositely arranged whiskers configured to determine the correct angular abutting position of the base cup on the body of the filter holder.

13. The filter holder of claim 1, wherein the filter holder body comprises a first material having a first thermal conductivity and the base cup comprises a second material having a second thermal conductivity, wherein the second thermal conductivity is less than the first thermal conductivity.

14. The filter holder of claim 13, wherein the second thermal conductivity is less than 5 W·m⁻¹·K⁻¹, preferably is less than 1 W·m⁻¹·K⁻¹, and preferably is between 0.1 W·m⁻¹·K⁻¹ and 0.5 W·m⁻¹·K⁻¹.

15. The filter holder of claim 13, wherein the second material comprises a material selected from the group comprising: polyethylene, low-density polyethylene, medium-density polyethylene, high-density polyethylene, polytetrafluoroethylene, methacrylate and acetal, or glass, ceramic, porcelain or any combination thereof.
